(19) United States
(12) Patent Application Publication
(10) Pub. No.: US 2016/0070803 A1
(43) Pub. Date: Mar. 10, 2016

(54) CONCEPTUAL PRODUCT RECOMMENDATION

(71) Applicant: Funky Flick, Inc., Santa Clara, CA (US)

(72) Inventor: Robert Nuckolls, Santa Clara, CA (US)

(21) Appl. No.: 14/480,918

(22) Filed: Sep. 9, 2014

(51) Int. Cl. G06F 17/30

(52) U.S. Cl. CPC G06F 17/30867; G06F 17/3053; G06F 17/30011

(57) ABSTRACT

A conceptual product recommendation service that allows users to define the parameters that drive a search for one or more target products as a concept that can be specified in a variety of different ways, ranging from the specification of an abstract or generic idea to the specification of a particular instance of a product that embodies one or more conceptual elements sought by the user. In the process of matching the user-specified concept to a set of target products, the conceptual product recommendation service compares a word vector based representation of a multi-document compilation relating to the user-specified concept to respective word vector based representations of multi-document compilations relating to the target products to produce respective match scores corresponding to degrees of match between the user-specified concept and the target products.

### BACKGROUND

A variety of different search systems have been developed to assist users in identifying products, such as movies, music, news, books, research articles, web pages, search queries, social tags, restaurants, and descriptions of persons on online dating platforms. These systems typically involve one or more collaborative or content-based filtering techniques. Collaborative filtering typically involves automatically predicting the interests of a user based on the preferences collected from the user and other users. Content-based filtering typically involves comparing product descriptions with a profile of the user's preferences. In another approach, recommendations are generated based on a conceptual or semantic matching process that involves parsing text information relating to a movie or other content into components (e.g., scenes or clips of a movie), assigning predefined semantics (e.g., concepts or themes, such as “chase scene,” “fight scene,” “anger,” and “happiness”) to these components based on the text information, indexing and categorizing the content based on the assigned semantics, and recommending contents based on the likelihoods that the semantics assigned to their respective components match user or group profiles or preferences.

### DESCRIPTION OF DRAWINGS

FIG. 1A is a diagrammatic view of an example of a recommendation system for recommending products to users.

FIG. 1B is a diagrammatic view of an example of a recommendation system for recommending products to users.

FIG. 2 is a flow diagram of an example of a product recommendation method.

FIGS. 3A-3C are diagrammatic views of a product recommendation user interface.

FIG. 4 is a diagrammatic view of an example of a data structure storing associations between search concepts and respective target products.

FIG. 5 is a diagrammatic view of an example of a system for generating conceptual mappings between target products and search concepts.

FIG. 6 is a diagrammatic view of an example of a method for generating conceptual mappings between target products and search concepts.

FIG. 7 is a diagrammatic view of an example of a method for generating conceptual mappings between target products and search concepts.

FIG. 8 is a block diagram of an example of a network node

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### 1. Definition of Terms

A “product” is any tangible or intangible good or service that is available for purchase or use.

A “document” is a persistent text based information record.

A “word group” is a set of word-based elements of a document and an assigned weight.

An “element” is a word, name, or phrase.

A “weight” is a numerical quantity assigned to an element that indicates an importance level of the element relative to other elements.

A “vector” is a set of one or more word groups.

“Classic literature” refers to written works judged over a period of time to be of the highest quality and outstanding of its kind.

“Punctuation” refers to marks, such as periods, commas, parentheses, page breaks, and other demarcations that are used in writing to separate, for example, chapters, paragraphs, sentences and other elements, and to clarify meaning.

A “computer” is any machine, device, or apparatus that processes data according to computer-readable instructions that are stored on a computer-readable medium either temporarily or permanently. A “computer operating system” is a software component of a computer system that manages and coordinates the performance of tasks and the sharing of computing and hardware resources. A “software application” (also referred to as software, an application, computer software, a computer application, a program, and a computer program) is a set of instructions that a computer can interpret and execute to perform one or more specific tasks. A “data file” is a block of information that durably stores data for use by a software application.

The term “computer-readable medium” (also referred to as “memory”) refers to any tangible, non-transitory medium capable storing information (e.g., instructions and data) that is readable by a machine (e.g., a computer). Storage devices suitable for tangibly embodying such information include, but are not limited to, all forms of physical, non-transitory computer-readable memory, including, for example, semiconductor memory devices, such as random access memory (RAM), EPROM, EEPROM, and Flash memory devices, magnetic disks such as internal hard disks and removable hard disks, magneto-optical disks, DVD-ROM/RAM, and CD-ROM/RAM.

A “network node” (also referred to simply as a “node”) is a physical junction or connection point in a communications network. Examples of network nodes include, but are not limited to, a terminal, a computer, and a network switch. A “server node” is a network node that responds to requests for information or service. A “client node” is a network node that requests information or service from a server node.

As used herein, the term “includes” means includes but not limited to, the term “including” means including but not limited to. The term “based on” means based at least in part on.

### 2. Conceptual Product Recommendation

A. Introduction

The examples that are described herein provide improved systems and methods for recommending products to users. These examples provide a conceptual product recommendation service that allows users to define the parameters that drive a search for one or more target products as a concept that can be specified in a variety of different ways, ranging from the specification of an abstract or generic idea (e.g., “courage” or “loneliness”) to the specification of a particular instance of a product (e.g., a particular movie, book, music, news item, web page, encyclopedia entry, or other document) that embodies one or more conceptual elements (e.g., idea, theme, mood, place, person, or item) sought by the user. In the process of matching the user-specified concept to a set of target products, the conceptual product recommendation service compares a word vector based representation of the user-specified concept to respective word vector based representations of multi-document compilations relating to the target products. In this way, these systems and methods provide results that better reflect the user's intention than other product recommendation approaches, such as those that rely on preconceived concepts or themes for matching products to user inputs or profile preferences.

B. Exemplary Operating Environment

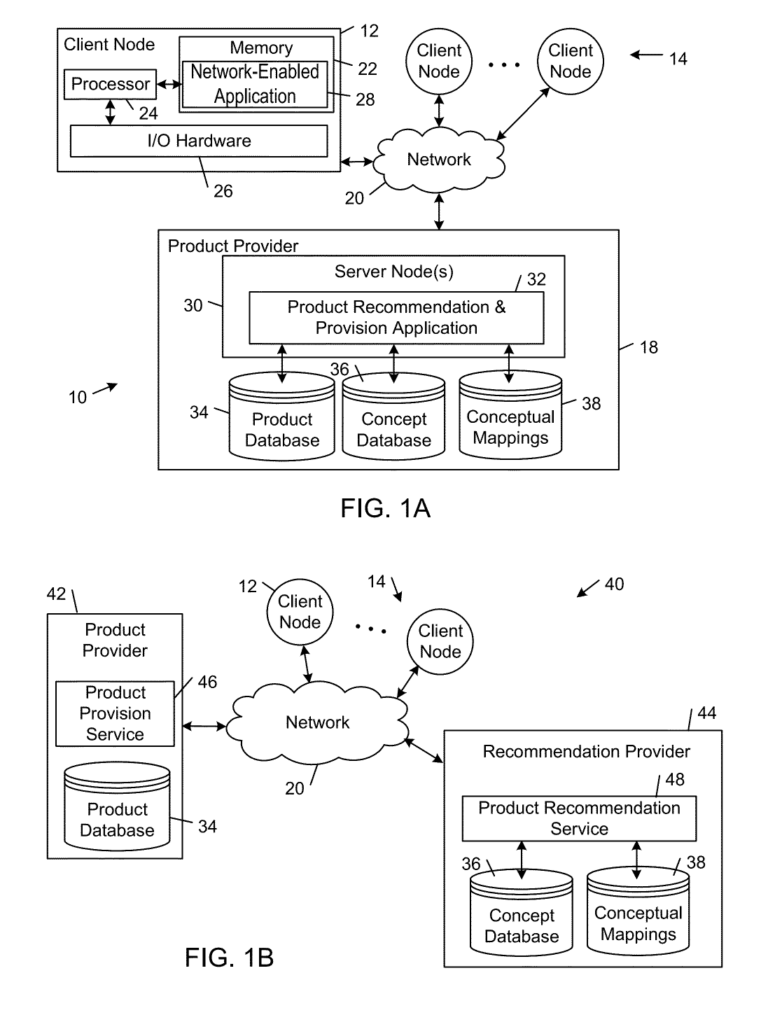

FIG. 1A shows an embodiment of an exemplary network communications environment 10 that includes a first client network node 12, one or more other client network nodes 14, and a product provider 18 that are interconnected by a network 20. The network 20 may include any of a local area network (LAN), a metropolitan area network (MAN), and a wide area network (WAN) (e.g., the internet). The network 20 typically includes a number of different computing platforms and transport facilities that support the transmission of a wide variety of different media types (e.g., text, voice, audio, and video) between network nodes 14 and the product provider 18.

The first client network node 12 includes a tangible computer-readable memory 22, a processor 24, and input/output (I/O) hardware 26 (including a display). The processor 24 executes at least one network-enabled application 28 (e.g., a web browser) that is stored in the memory 22. Each of the other client network nodes 14 typically is configured in substantially the same general way as the first client network node 12, with a tangible computer-readable memory storing at least one communications application, a processor, and input/output (I/O) hardware (including a display).

The product provider 18 includes at least one server network node 30 that includes a product recommendation and provision application 32 that hosts a product recommendation and provision service. In some examples, the product provider 18 is a content source (e.g., Amazon.com, Netflix, Inc., Comcast Corporation, and Apple Inc.) that supplies digital media content to the users' client network nodes 12, 14. The product recommendation and provision service maintains a product database 34, a concept database 36, and a conceptual mappings database 38. The product database 34 includes records that describe various target products (e.g., physical products, non-physical products, or both physical and non-physical products) that are available from the product provider 18. In some examples, the product database 34 also includes digital media content or links to digital media content that may be transmitted to the client network nodes 12, 14. The products listed in the product database 34 typically correspond to a particular market, which may encompass one or more product categories. The listed products within each product category may encompass a particular segment (e.g., all movies having a popularity above a threshold level) within that product category. The concept database 36 includes records that describe various search concepts. The concepts listed in the concept database 36 may be selected in a wide variety of different ways. In some examples, the selected concepts correspond to all of the products in the product database 34 and a subset of the entries in an online encyclopedia (e.g., Wikipedia). The conceptual mappings database 38 includes records that describe associations between the search concepts and respective ones of the target products.

FIG. 1B shows an embodiment of another exemplary network communications environment 40 that essentially corresponds to the network communications environment 10, except that the services provided the product provider 18 in the network communications environment 10 are distributed across a product provider 42 and a recommendation provider 44. In particular, the product provision service 46 provides access to the product database 34 to the recommendation provider 44 for generating product recommendations for the users of respective ones of the client network nodes 12, 14, and supplies selected ones of the recommended products to the users. The recommendation service 44 generates the product recommendations for the users based on the mappings described in the conceptual mappings database 48, as described in detail below.

C. Interfacing Users With the Conceptual Product Recommendation Service

In response to user input, the product recommendation service returns a ranked list of product descriptions (e.g., titles or synopses) from the product database 34 that match the user-specified concept based on the mappings described in the conceptual mappings database 38, as described in detail below.

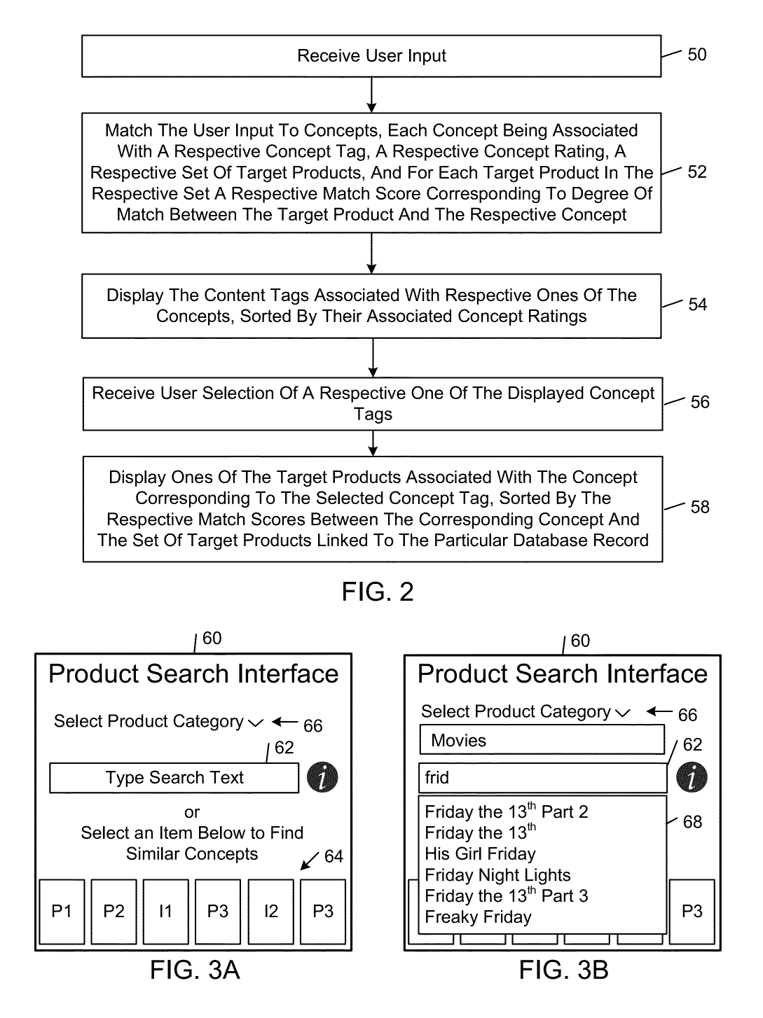

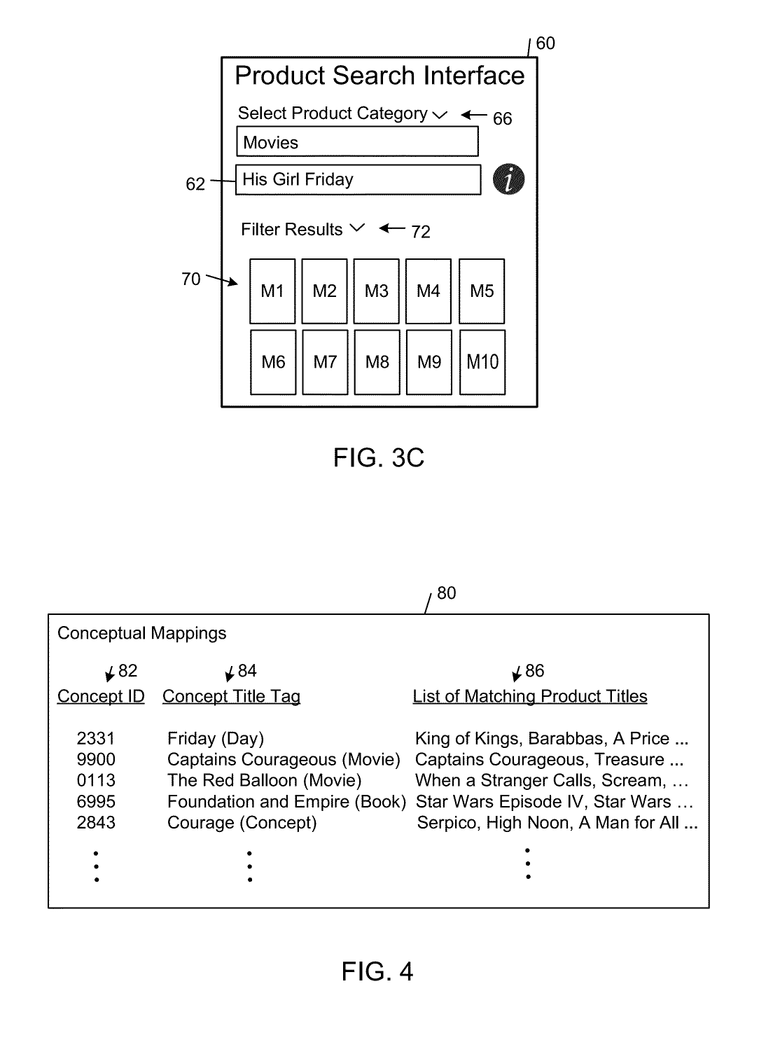

FIG. 2 shows an example of a method by which a user interfaces with the conceptual product recommendation service after connecting to the product recommendation service through the network-enabled application 28 running on a respective one of the client network nodes 12, 14. FIGS. 3A-3C show examples of a product recommendation user interface 60 at different stages of the process of delivering product recommendations to a user.

In accordance with the method of FIG. 2, the conceptual product recommendation service receives user input (FIG. 2, block 50). The user input may be textual input (e.g., one or more words) or a selection of a predetermined list of concepts. Referring to FIG. 3A, the user interface 60 includes a text input box 62 for receiving textual input from the user and a pre-generated set of icons 64 representing respective concepts that may correspond to abstract or generic ideas (e.g., ideas 11 and 12) or particular instances of products (e.g., P1, P2, and P3). The user interface 60 also includes a Product Category dropdown menu 66 that allows the user to optionally select a product category from a predetermined set of product categories (e.g., movies, music, news, books, research articles, web pages, search queries, social tags, restaurants, and descriptions of persons on online dating platforms).

As the user enters text into the text input box 62, the product recommendation service automatically matches the user input to concepts (FIG. 2, block 52). As explained in detail below, in some examples, each concept is associated with a respective concept tag (e.g., a concept title), a respective concept rating, a respective set of target products, and for each target product in the respective set a respective match score corresponding to degree of match between the target product and the respective concept.

The product recommendation service displays the content tags that are associated with respective ones of the concepts, sorted by their associated concept ratings (FIG. 2, block 54). Referring to FIG. 3B, the user interface 60 presents a dropdown list that contains a ranked list of concept tags that the product recommendation service determines dynamically based on the text currently entered into the text input box 62 and a product category if one is selected. In the illustrated example, the user has selected the “Movies” product category from the Product Category dropdown menu 66, and the product recommendation service has matched the input text “frid” to the following sorted list of concept movie titles 68: Friday the 13^{th} Part 2; Friday the 13^{th}; His Girl Friday; Friday Night Lights; Friday the 13^{th} Part 3; and Freaky Friday.

The product recommendation service receives user selection of a respective one of the displayed concept tags (FIG. 2, block 56) and, in response, the product recommendation service displays respective ones of the target products associated with the concept corresponding to the selected concept tag, sorted by the respective match scores between the corresponding concept and the set of target products linked to the particular database record (FIG. 2, block 58). Referring to FIG. 3C, the user interface 60 presents a sorted list of target movies 70 (i.e., M1, . . . , M10) based on the user's selection of the “movies” product category from the dropdown menu 66 and the user's selection of the “His Girl Friday” movie title from the sorted list of concept movie titles 68. The user interface 60 also includes a Filter Results dropdown menu 72 that allows the user to filter the sorted list of target movies 70 based on one or more criteria (e.g., genre or era).

FIG. 4 shows an example of a data structure 80 that stores associations between search concepts and respective target products. The data structure 80 includes a Concept ID field 82, a Concept Title tag field 84, and a List of Matching Product Titles field 86. In the illustrated example, there is a unique Concept ID for each predetermined concept that is supported by the product recommendation system. The list of the Concept IDs typically is ordered in the data structure 80 by commonality. In some examples, the Concept IDs in the list are ordered by the frequency with which the Concept Title Tags are mentioned in the corpus of the multi-document compilations that are used to generate the target word vectors representing the target products in the conceptual mapping process described in detail below. Each Concept ID 82 is associated with a respective one of the Concept Title Tags 84 and a respective one of the Lists of Matching Product Titles 86. Each Concept Title Tag 84 corresponds to a respective concept title, which may be, for example, the name of a generic or abstract concept (e.g., the noun “courage” or the day “Friday”) or the title associated with a particular product (e.g., the title of a movie or a book). Each List of Matching Product Titles 86 corresponds to a list of the Title Tags of the products that match the concept associated with the respective Concept ID, sorted by the degree of match between the concept and the listed products.

In some examples, if user input in the text input box 62 matches a respective one of the Concept Title Tag entries 84, the product recommendation service automatically displays the associated sorted list of Matching Product Titles 86. If the user input matches more than one of the Concept Title Tag entries 84, the matching Concept Title Tag entries 84 are displayed in the drop-down menu 68 (FIG. 3B) in the order that they are listed in the data structure 80.

D. Conceptually Mapping Concepts to Products

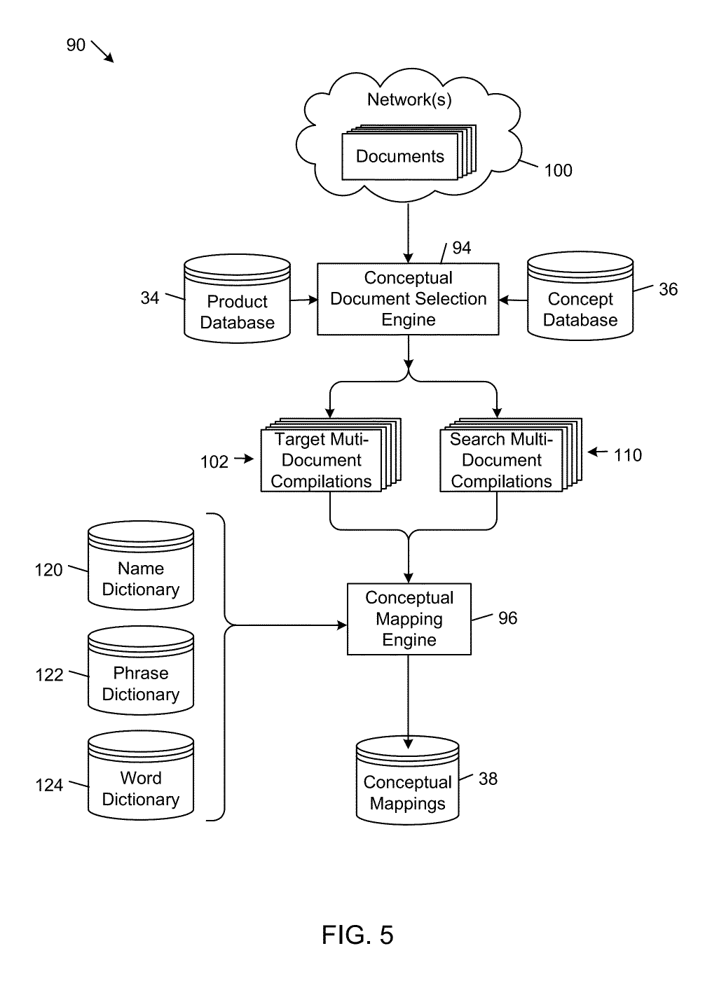

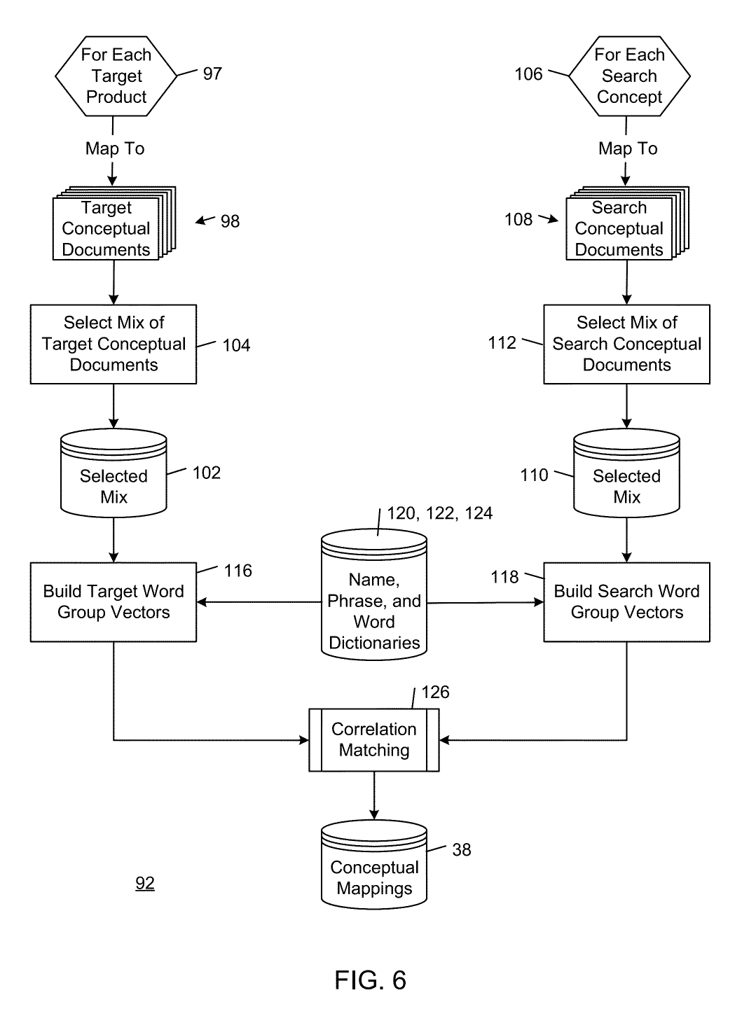

FIGS. 5 and 6 respectively show examples of a conceptual mapping system 90 and a conceptual mapping method 92 for generating the conceptual mappings 38 between target products listed in the product database 34 and search concepts listed in the concept database 36. The conceptual mapping system 90 includes a conceptual document selection engine 94 and a conceptual mapping engine 96.

For each product listed in the product database 34 (FIG. 6, block 97), the conceptual document selection engine 94 identifies a set of target conceptual documents 98 on one or more networks 100 (e.g., the internet) that relate to the product. This process typically involves targeting a particular product market to be conceptually searched (e.g., movies or books), and collecting textual documents relating to the target product market. The collected documents may include: objective descriptions of target products; user and critical reviews of the target products; and technical specifications of the target products. Additional supporting text also may be generated if the collected documents are deemed to be incomplete or otherwise insufficient.

Based on an analysis of the identified target conceptual documents 98, the conceptual document selection engine 94 selects a respective mix 102 of target conceptual documents 98 (also referred to as a “target multi-document compilation”) that conceptually “describes” the product (FIG. 6, block 104).

In some examples, for each of respective ones of the target products, the conceptual document selection engine 94 selects different types of the identified target conceptual documents 98 for the respective mix 102. Exemplary document types include descriptive documents that include descriptions of the target product, review documents that include reviews of the target product (e.g., user reviews and professional critic reviews), and reference documents that include technical specifications of the target product (e.g., for movies, technical specifications include director, actors, release date, title, characters, synopsis, etc.). In some examples, one or more product types are associated with a respective target proportions of document content from descriptive documents, review documents, and reference documents. In these examples, for each of respective ones of the target products, the conceptual document selection engine 94 selects document content from descriptive documents, review documents, and reference documents based on the respective target proportion associated with the type of the target product. In some examples, each of the movie and book product types is associated with a target document proportion of document content selected from user review documents, critic review documents, and reference documents with the proportion of document content from user review documents being greater than the proportions of document content from critic review documents and reference documents combined. In one example, each of the movie and book product types is associated with a target document proportion of document content selected from four parts user review documents, one part critic review documents, and one part reference documents.

Similarly, for each concept listed in the concept database 36 (FIG. 6, block 106), the conceptual document selection engine 94 identifies a set of search conceptual documents 108 on the one or more networks 100 that relate to the concept and, based on an analysis of the identified search conceptual documents 108, the conceptual document selection engine 94 selects a respective mix 110 of search conceptual documents 108 (also referred to as a “search multi-document compilation”) that conceptually “describes” the concept (FIG. 6, block 112). In some examples, one or more of the target products in the product database 34 are used as search concepts in the concept database 36. For each these target products, the same respective mix of target conceptual documents is used to build the corresponding target word group vector 116 and the corresponding search word group vector 118.

For each product listed in the product database 34, the conceptual mapping engine 96 determines a respective target word vector representation of the respective target multi-document compilation (FIG. 6, block 116). Similarly, for each concept listed in the concept database 36, the conceptual mapping engine 96 determines a respective search word vector representation of the respective search multi-document compilation (FIG. 6, block 118). As explained in detail below, the determination of the target and search word vectors is based on identification of word-based elements of the respective multi-document compilations in a name dictionary 120, a weighted phrase dictionary 122, and a weighted word dictionary 124.

For each concept in the concept database 36, the conceptual mapping engine 96 compares the search word vector and respective ones of the target word vectors to associate the concept with target products and respective match scores corresponding to degrees of match between the concept and the respective target products (FIG. 6, block 126). The resulting mappings are stored by one or more data structures in the conceptual mappings database 38.

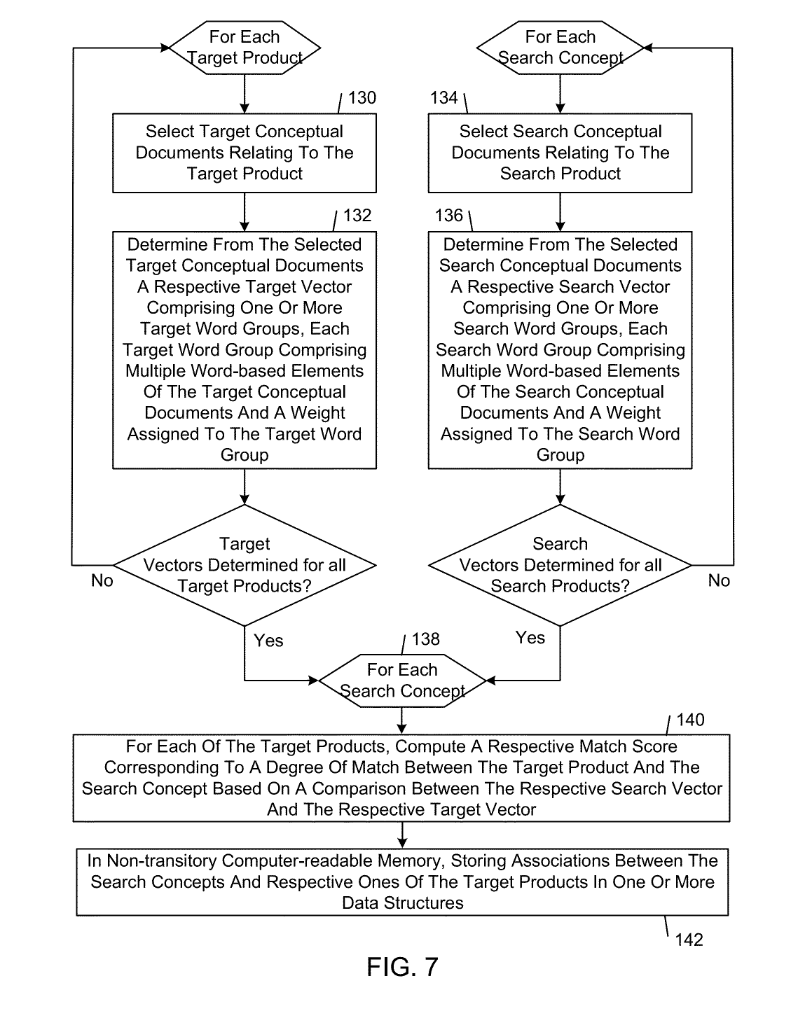

FIG. 7 is a diagrammatic view of an example of a method for generating conceptual mappings between target products and search concepts.

In accordance with the method of FIG. 7, for each of multiple target products, the product recommendation service selects target conceptual documents relating to the target product (FIG. 7, block 130), and determines from the selected target conceptual documents a respective target vector comprising one or more target word groups, each target word group comprising multiple word-based elements of the target conceptual documents and a weight assigned to the target word group (FIG. 7, block 132).

For each of multiple search concepts, the product recommendation service chooses search conceptual documents relating to the search concept (FIG. 7, block 134), and ascertaining from the chosen search conceptual documents a respective search vector comprising search word groups, each search word group comprising multiple word-based elements of the search conceptual documents and a weight assigned to the search word group (FIG. 7, block 136).

In some examples, the product recommendation service chooses the search conceptual documents by analyzing respective ones of the selected target conceptual documents for references to entries in an online encyclopedia (e.g., Wikipedia), and choosing a number of the most highly referenced ones of the entries in the online encyclopedia as search conceptual documents. These entries may include, for example, words (e.g., “brain” and “whistling”), names (e.g., Julius Caesar and Tony Curtis), or phrases (e.g., “labor camp” or “muscle car”). In addition, the selected target conceptual documents themselves may be used as search conceptual documents to search other target search documents. For example, if the target products consisted of a selection of books, the target conceptual document “Moby-Dick” may be used as a search conceptual document to find other books that are similar to “Moby-Dick” such as “Hunters of the Dark Sea” by Mel Odom. Likewise, for movies, a user may want to know movies that are similar to his favorite movies.

In some examples, search conceptual documents may be prepared to extract common classifications and lists from the selected target conceptual documents. Such search conceptual documents may be used to search for lists of targets. For example, if the target product type is movies, then a search conceptual document that includes a brief description of all the movies that won the Best Picture Oscar might be used to obtain a list of movies that won the Best Picture Oscar award.

In some examples, the process of determining the target and search vectors involves, for each of the respective conceptual documents: identifying names corresponding to names in a names dictionary comprising names of famous people, places, and events; identifying word sequences corresponding to phrases in a phrase dictionary and assigning to the identified phrases respective weights specified in the phrase dictionary; and identifying individual words corresponding to words in a word dictionary and assigning to the individual words respective weights specified in the word dictionary. This process additionally involves, for each of the conceptual documents: forming a respective word group from a respective pairing of each word-based element of the conceptual document with each subsequent word-based element in a sliding window of text of the conceptual document; assigning a respective weight to each word group formed; and reducing the weight assigned to each word group based on extents to which word based elements and punctuation appear between the constituent words of the word group in the respective conceptual document.

For each search concept (FIG. 7, block 138), the product recommendation service computes a respective match score corresponding to a degree of match between the target product and each search concept based on a comparison between the respective search vector and the respective target vector (FIG. 7, block 140). In some examples, this process involves normalizing the weights in at least one of the target vector and the search vector to account relative sizes of the selected sets of target conceptual documents (i.e., target multi-document compilations) and the chosen sets of search conceptual documents (i.e., search multi-document compilations), and the normalizing comprises adjusting the weights in the at least one target vector based on an analysis of the contents of the set of target conceptual documents selected for the respective target product. In addition, this process further involves for each of the search concepts: for each of the target products, identifying target word groups in the respective target vector that match search word groups in the search vector corresponding to the search concept; for each of the target products, multiplying the respective weights of the identified matching word groups to obtain respective product values; and for each of the target products, calculating the match score for the search concept based on a sum of all the product values.

In non-transitory computer-readable memory, the product recommendation service stores associations between the search concepts and respective ones of the target products in one or more data structures permitting computer-based generation of lists of respective ones of the target products sorted by the respective match scores in response to respective queries comprising respective ones of the search concepts (FIG. 7, block 142). In some examples, for each of the search concepts, the one or more data structures store a respective list of respective ones the target products sorted according to their respective match scores with the search concept. In some examples, the product recommendation service generates lists of respective ones of the target products sorted by the respective match scores by applying respective queries comprising respective ones of the search concepts to the one more data structures stored in the memory.

E. Dictionaries

As explained above, the determination of the target and search word vectors is based on identification of word-based elements of the respective multi-document compilations in a name dictionary 120, a weighted phrase dictionary 122, and a weighted word dictionary 124. In some examples, these dictionaries are created as follows.

The name dictionary is created by collecting the names of famous people (e.g., Alexander the Great), places (e.g., London), and events (e.g., Battle of the Bulge). In this process, if two names indicate the same person, the two names are combined into a single name. For example, the names Bill Clinton, President Clinton, and President Bill Clinton all would be referred to President Bill Clinton. Common last names, such as Murray, also are included in the name dictionary. Last names that conflict with names of common words, such as “little” or “west” are not used. Titles such as Mrs., Captain, and President are included in the name dictionary. Names are not given a weight in the name dictionary; instead they are weighted when they are paired with a word or phrase into a word group.

The word dictionary is created by starting with a normal English dictionary, excluding proper nouns that are in the Names dictionary, and weighting each remaining word (including abbreviations) according to its commonality, preciseness, use in classic literature, and emotion. In this process, qualities of words are assessed according to statistics obtained from words extracted from a collection of classic literature, and weights are assigned to words in the word dictionary based at least in part on the assessed qualities of the words. In addition, the precisions of words are assessed based on respective counts of different meanings that are associated with the words, and weights are assigned to words in the word dictionary based at least in part on the assessed precision of the words. If words are used commonly, they are weighted lower; if they are rare they are weighted higher. Words such as “the” or “with” are used so commonly they are assigned a weight of zero and not used in the word vector correlation process. If words have multiple meanings their weight is reduced. For example, “hit” would be penalized because it has many meanings depending on the context. This is determined by examining a normal English dictionary and counting the number of different meanings of a word. If a word needs context to be useful it is weighted lower. For example, “army” needs the additional context of who owns the army (British, Roman etc.). Words that have strong meanings are rated higher. For example “abhorrent” is assigned a higher weight than “abduct” because it adds extra energy in a sentence. If words appear more often in “classic books” (e.g., Moby-Dick and The Hobbit) they are weighted more heavily.

The phrase dictionary includes consecutive normal words that are commonly seen in English text and have special meaning when placed together. For example, “affirmative action” or “hot and bothered.” If two or more consecutive words change their meaning when combined (e.g., “spaghetti western”) they are placed in a phrase dictionary and given a higher weight. Weights also are assigned to phrases according to the commonality, preciseness, use in classic literature, and emotion criteria described above. If two or more consecutive words are commonly placed together in text and either one or both are low weight words (e.g., “time travel”), they are combined into a phrase with greater weight. If two or more consecutive words both have high weights in the word dictionary, they are not placed in the phrase dictionary unless the consecutive words change their meaning when combined. In other words, the phrases in the phrase dictionary consisting of two or more consecutive words that are assigned relatively high weights in the word dictionary are phrases whose meanings are not suggested by their constituent words. Application of this criterion would preclude the inclusion of “river boat” in the phrase dictionary.

In some examples, respective ones of the names dictionary, the phrase dictionary, and the word dictionary are modified based on an analysis of the corpus of target conceptual documents that are selected for the target products. In these examples, respective ones of the weights in one or more of the names dictionary, the phrase dictionary, and the word dictionary are modified based on commonality of words in the target conceptual documents. For example, in movie descriptions the word “actor” typically is extremely common and therefore its assigned weight would be reduced. In addition, respective ones of the names dictionary, the phrase dictionary, and the word dictionary are modified to include new names, phrases, and words (including slang) identified in the selected target conceptual documents.

F. Extracting Word Group Vectors

The process of extracting word group vector representations from conceptual documents is the same for both target conceptual documents and search conceptual documents. This process involves scanning through the target and search conceptual documents to form names, words, and phrases. In this process, multiple words may be compressed into a new entity and all punctuation is saved.

Initially, the target and search conceptual documents are scanned to form names. All the names in the scanned documents that appear in the name dictionary are formed. If a single proper noun is not part of a sequence, appeared previously in the document as the end of a collected multiple sequence name, and is marked as a last name in the name dictionary, the single proper noun is recorded as equivalent to the previous multiple sequence name. For example, if the name Smith appears in a document and the name Adam Smith previously was found in the document, then Smith is converted to Adam Smith.

Word sequences in the target and search conceptual documents that match entries in the phrase dictionary are formed and weighted according to the weights in the phrase dictionary.

Individual words in the target and search conceptual documents that match entries in the word dictionary are formed and weighted according to the weights in the word dictionary. If a word has a weight of zero because it is very common (e.g., “can” and “then”), it is deleted from the text and not used in the correlation. Numbers and dates found in the documents are weighted. Dates are given a nominal weight unless they specify a famous event. All numbers that are not part of dates are counted as words. Small numbers have a minimal weight and larger numbers a normal weight.

For each target and search conceptual document, all the elements of the document are paired into word groups by searching forwards through the document and pairing the current element with all subsequent elements and assigning a weight to each word group that is formed. The initial word group weight is defined as the largest weight of the two elements extracted from the word or phrase dictionary. Since names have no weight, the names take on the weights assigned to the word or phrase with which they are paired. The distance between two elements in a document is defined as the number of elements they are apart linearly in the text.

In some examples, the weight of the word group is reduced proportionally with the distance. In one example, the reduced weight (w(new)) is equal to three times the original weight (w) divided by two times the distance (d) (i.e., w(new)=(3·w)/(2·d)). For example, if there are two words with weight w0=5 and w1=9, and they are 5 elements apart, a new word group would be formed with a weight given by:

weight(word group)=(3·max(9, 5))/(5·2)=2.7

In some examples, the constants 3 and 2 in the equation can be altered +/−10% depending on the type of documents being processed.

All punctuation (including paragraph and chapter crossings) between two elements to be gathered into a word group is collected. Depending on the type of punctuation and the frequency of its occurrence, the weight is reduced. In some examples, the weight reduction increases with position in the following punctuation sequence, with commas being associated with the least reduction in weight and end of chapters being associated with the most reduction in weight: comma; semicolon; colon; end of sentence; bullets; end of paragraph; and end of chapter.

Two names cannot form a word group. For example, the word group [Adam Smith, Victor Hugo, weight] is not allowed.

A word group cannot have equal elements. For example, [bald, bald, weight] is not allowed. If this pattern is encountered for a given element, the search forward for the given element is stopped and word group forming process is started for the next element.

Element pairs are stored alphabetically; the order in which the elements were extracted from the document is not used. For example, [man, bad, weight] would be stored as [bad, man, weight].

If, after generating a word group vector, any two word groups in the vector have equal elements, the word groups are combined into a single word group that is assigned a weight equal to the sum of the weights of the two word groups.

G. Recommending Target Products

As explained above, the conceptual mapping engine 96 performs a correlation matching process that generates match scores corresponding to degrees of match between the search concepts and the target products based on comparisons between the respective search word vectors and the respective target word vectors.

Before performing the correlation process, the conceptual mapping engine 96 normalizes the weights in the target and search vectors to account for differences in the relative sizes of the selected target conceptual documents and the chosen search conceptual documents. In some examples, the weights normalization is accomplished in each vector by dividing all non-normalized weights (weight(original)) according to the equation:

weight(normalized)=weight(original)/((document size)^{EXP})

In some examples, the value of the exponent EXP is altered ±10% depending on the types of documents being processed. For example, documents with a large amount of technical data are normalized with an EXP value reduced by −10%, and documents with a large amount conversation are normalized with an EXP value increased by +10%. A typical value for EXP is 0.46.

After the target and search vector weights have been normalized, the conceptual mapping engine 96 performs a correlation matching process. In some examples, this process involves performing a vector correlation operation that operates on two word group vectors to generate a final correlation single fixed-point number value (referred to as a “match score”). In accordance with this operation, the two word group vectors are compared. If any two word groups have equal elements, their weights are multiplied. All the multiplied word group weights are summed and the resulting sum is the final correlation value of the two word group vectors. For each search vector, the vector correlation operation is applied to all target vectors. This results in a vector of match scores equal in length to the number of target multi-document compilations (i.e., the number of target products). The correlation results for each search multi-document compilations are sorted by match score to produce an ordered list of the most similar target multi-document compilations, which corresponds to an ordered list of the most similar target products.

### 3. Exemplary Network Nodes

Users typically access a network communication environment from respective network nodes. Each of these network nodes typically is implemented by a general-purpose computer system or a dedicated communications computer system (or “console”). Each network node executes communications processes that connect with one or both of the product recommendation provider and the product provider.

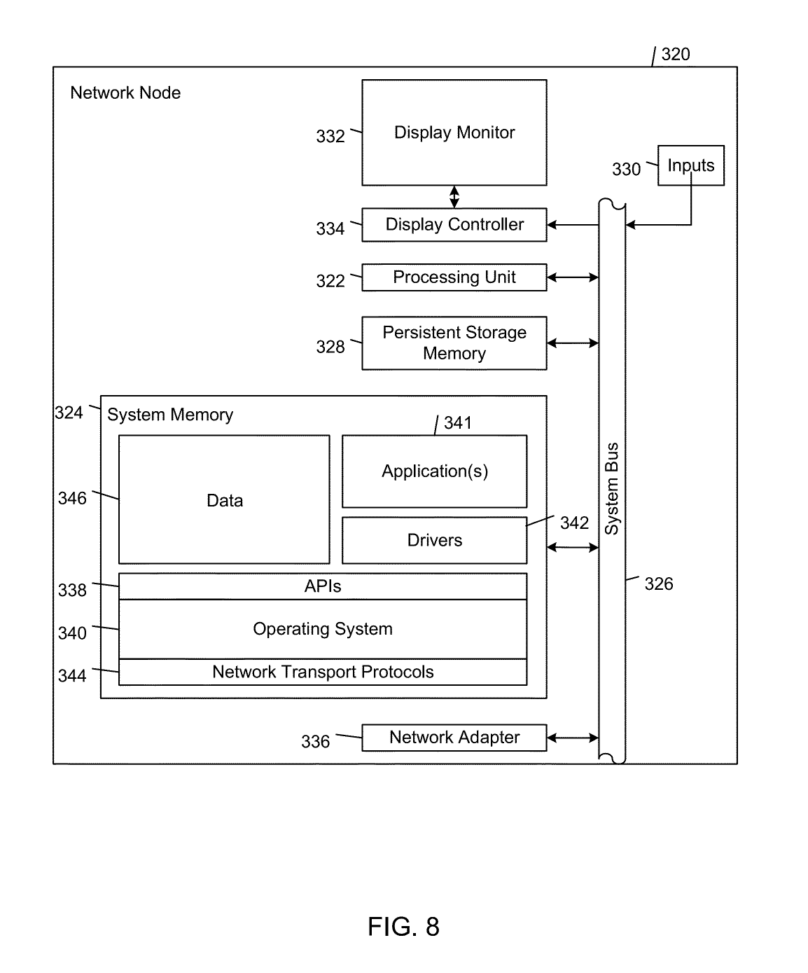

FIG. 8 shows an exemplary embodiment of a client network node that is implemented by a computer system 320. The computer system 320 includes a processing unit 322, a system memory 324, and a system bus 326 that couples the processing unit 322 to the various components of the computer system 320. The processing unit 322 may include one or more data processors, each of which may be in the form of any one of various commercially available computer processors. The system memory 324 includes one or more computer-readable media that typically are associated with a software application addressing space that defines the addresses that are available to software applications. The system memory 324 may include a read only memory (ROM) that stores a basic input/output system (BIOS) that contains start-up routines for the computer system 320, and a random access memory (RAM). The system bus 326 may be a memory bus, a peripheral bus or a local bus, and may be compatible with any of a variety of bus protocols, including PCI, VESA, Microchannel, ISA, and EISA. The computer system 320 also includes a persistent storage memory 328 (e.g., a hard drive, a floppy drive, a CD ROM drive, magnetic tape drives, flash memory devices, and digital video disks) that is connected to the system bus 326 and contains one or more computer-readable media disks that provide non-volatile or persistent storage for data, data structures and computer-executable instructions.

A user may interact (e.g., input commands or data) with the computer system 320 using one or more input devices 330 (e.g. one or more keyboards, computer mice, microphones, cameras, joysticks, physical motion sensors such Wii input devices, and touch pads). Information may be presented through a graphical user interface (GUI) that is presented to the user on a display monitor 332, which is controlled by a display controller 334. The computer system 320 also may include other input/output hardware (e.g., peripheral output devices, such as speakers and a printer). The computer system 320 connects to other network nodes through a network adapter 336 (also referred to as a “network interface card” or NIC).

A number of program modules may be stored in the system memory 324, including application programming interfaces 338 (APIs), an operating system (OS) 340 (e.g., the Windows® operating system available from Microsoft Corporation of Redmond, Wash. U.S.A.), software applications 341 including the network enabled application 28, drivers 342 (e.g., a GUI driver), network transport protocols 344, and data 346 (e.g., input data, output data, program data, a registry, and configuration settings).

In some embodiments, the one or more server network nodes of the product providers 18, 42, and the recommendation provider 44 are implemented by respective general-purpose computer systems of the same type as the client network node 320, except that each server network node typically includes one or more server software applications.

In other embodiments, the one or more server network nodes of the product providers 18, 42, and the recommendation provider 44 are implemented by respective network devices that perform edge services (e.g., routing and switching).

### 4. Conclusion

The embodiments that are described herein provide improved systems and methods for recommending products to users.

Other embodiments are within the scope of the claims.

1. A method, comprising by computing apparatus:
for each of multiple target products,
selecting target conceptual documents relating to the target product, and
determining from the selected target conceptual documents a respective target vector comprising one or more target word groups, each target word group comprising multiple word-based elements of the target conceptual documents and a weight assigned to the target word group;
for each of multiple search concepts,
choosing search conceptual documents relating to the search concept,
ascertaining from the chosen search conceptual documents a respective search vector comprising search word groups, each search word group comprising multiple word-based elements of the search conceptual documents and a weight assigned to the search word group, and
for each of the target products, computing a respective match score corresponding to a degree of match between the target product and the search concept based on a comparison between the respective search vector and the respective target vector; and
in non-transitory computer-readable memory, storing associations between the search concepts and respective ones of the target products in one or more data structures permitting computer-based generation of lists of respective ones of the target products sorted by the respective match scores in response to respective queries comprising respective ones of the search concepts.

2. The method of claim 1, wherein the selecting comprises, for each of respective ones of the target products, selecting different types of documents from descriptive documents comprising descriptions of the target product, review documents comprising reviews of the target product, and reference documents comprising technical specifications of the target product.

3. The method of claim 2, wherein:
the target products comprise products of different product types;
each of the product types is associated with a respective target proportion of document content from descriptive documents, review documents, and reference documents; and
the selecting comprises, for each of respective ones of the target products, selecting document content from descriptive documents, review documents, and reference documents based on the respective target proportion associated with the product type of the target product.

4. The method of claim 3, wherein the product types comprise movies and book, and each of the movies and books product types is associated with a target document proportion of document content selected from user review documents, critic review documents, and reference documents with the proportion of document content from user review documents being greater than the proportions of document content from critic review documents and reference documents combined.

5. The method of claim 1, wherein the choosing of the search conceptual documents comprises analyzing respective ones of the selected target conceptual documents for references to entries in an online encyclopedia, and choosing a number of the most highly referenced ones of the entries in the online encyclopedia as search conceptual documents.

6. The method of claim 1, wherein each of the determining and the ascertaining comprises, in each of the respective conceptual documents:
identifying names corresponding to names in a names dictionary comprising names of famous people, places, and events;
identifying word sequences corresponding to phrases in a phrase dictionary and assigning to the identified phrases respective weights specified in the phrase dictionary; and
identifying individual words corresponding to words in a word dictionary and assigning to the individual words respective weights specified in the word dictionary.

7. The method of claim 6, further comprising assessing qualities of words according to statistics obtained from words extracted from a collection of classic literature, and assigning weights to words in the word dictionary and phrases in the phrase dictionary based at least in part on the assessed qualities of the words.

8. The method of claim 6, further comprising assessing precision of words based on respective counts of different meanings that are associated with the words, and assigning weights to words in the word dictionary and phrases in the phrase dictionary based at least in part on the assessed precision of the words.

9. The method of claim 6, wherein the phrases in the phrase dictionary consisting of two or more consecutive words that are assigned relatively high weights in the word dictionary are phrases whose meanings are not suggested by their constituent words, and all other phrases in the phrase dictionary consist of two or more consecutive words that are assigned relatively low weights in the word dictionary.

10. The method of claim 6, further comprising modifying respective ones of the names dictionary, the phrase dictionary, and the word dictionary based on an analysis of the selected target conceptual documents.

11. The method of claim 10, wherein the modifying comprises modifying respective ones of the weights in one or more of the names dictionary, the phrase dictionary, and the word dictionary based on commonality of words in the selected target conceptual documents.

12. The method of claim 10, wherein the modifying comprises modifying respective ones of the names dictionary, the phrase dictionary, and the word dictionary to include new names, phrases, and words identified in the selected target conceptual documents.

13. The method of claim 6, wherein the determining comprises for each of the target conceptual documents: forming a respective word group from a respective pairing of each word-based element of the target conceptual document with each subsequent word-based element in a sliding window of text of the target conceptual document; assigning a respective weight to each word group formed; and reducing the weight assigned to each word group based on extents to which word based elements and punctuation appear between the constituent words of the word group in the respective target conceptual document.

14. The method of claim 1, wherein the computing comprises normalizing the weights in at least one of the target vector and the search vector to account relative sizes of the selected target conceptual documents and the chosen search conceptual documents, and the normalizing comprises adjusting the weights in the at least one target vector based on an analysis of content of the target conceptual documents selected for the respective target product.

15. The method of claim 1, wherein, for each of the search concepts, the computing comprises:
for each of the target products,
identifying target word groups in the respective target vector that match search word groups in the search vector corresponding to the search concept;
multiplying the respective weights of the identified matching word groups to obtain respective product values; and
calculating the match score for the search concept based on a sum of all the product values.

16. The method of claim 1, further comprising generating lists of respective ones of the target products sorted by the respective match scores by applying respective queries comprising respective ones of the search concepts to the one more data structures stored in the memory.

17. The method of claim 1, wherein, for each of the search concepts, the one or more data structures store a respective list of respective ones the target products sorted according to their respective match scores with the search concept.

18. A non-transitory computer-readable medium comprising instructions that, when executed by a processor, cause the computer to perform operations comprising:
for each of multiple target products,
selecting target conceptual documents relating to the target product, and
determining from the selected target conceptual documents a respective target vector comprising one or more target word groups, each target word group comprising multiple word-based elements of the target conceptual documents and a weight assigned to the target word group;
for each of multiple search concepts,
choosing search conceptual documents relating to the search concept,
ascertaining from the chosen search conceptual documents a respective search vector comprising search word groups, each search word group comprising multiple word-based elements of the search conceptual documents and a weight assigned to the search word group, and
for each of the target products, computing a respective match score corresponding to a degree of match between the target product and the search concept based on a comparison between the respective search vector and the respective target vector; and
in non-transitory computer-readable memory, storing associations between the search concepts and respective ones of the target products in one or more data structures.

19. A method, comprising:
receiving user input;
matching the user input to concepts, each concept being associated with a respective concept tag, a respective concept rating, a respective set of target products, and for each target product in the respective set a respective match score corresponding to degree of match between the target product and the respective concept;
displaying the content tags associated with respective ones of the concepts, sorted by their associated concept ratings;
receiving user selection of a respective one of the displayed concept tags; and
displaying respective ones of the target products associated with the concept corresponding to the selected concept tag, sorted by the respective match scores between the corresponding concept and the set of target products linked to the particular database record.

20. The method of claim 19, further comprising, for each of the concepts, ascertaining the respective match scores between the concept and the target products based on comparisons of vectors of word groups respectively extracted from a collection of search conceptual documents associated with the concept and respective collections of target conceptual documents respectively associated with the target products.

21. The method of claim 20, wherein each concept rating relates to a respective frequency with which the associated concept appears in the collections of target conceptual documents.
